(19) United States
(12) Patent Application Publication
(10) Pub. No.: US 2001/0008404 A1
(43) Pub. Date: Jul. 19, 2001

(54) Information adjusting/presenting device and method

(76) Inventors: Hirohisa Naito, Kawasaki (JP); Minoru Sekiguchi, Kawasaki (JP); Kuniharu Takayama, Kawasaki (JP); Yoshiharu Maeda, Kawasaki (JP)

Correspondence Address: STAAS & HALSEY LLP, 700 11TH STREET, NW, SUITE 500, WASHINGTON, DC, 20001, US

(21) Appl. No.: 09/796,631

(22) Filed: Mar. 2, 2001

Related U.S. Application Data
(63) Continuation of application No. PCT/JP99/01155, filed on Mar. 10, 1999.

(30) Foreign Application Priority Data
Sep. 25, 1998 (JP) 10-270672

(51) Int. Cl. G06F 3/00

(52) U.S. Cl. 345/745; 345/844

(57) ABSTRACT

An information presenting device obtains information from a variety of information sources and adjusts the amount of information to be presented to a user to a unit period acquisition information amount. The information presenting device also adjusts presenting timing based on a user's behavior and presents the adjusted amount of information to a user at the adjusted timing.

### CROSS REFERENCE TO RELATED APPLICATION

This application is a continuation of International PCT Application No. PCT/JP99/01155 filed on Mar. 10, 1999.

### BACKGROUND OF THE INVENTION

1. Field of the Invention

The present invention relates to an information presenting device for adjusting information based on the type of information, the behavior of a user, an environmental situation, etc., and presenting the adjusted information to a user and a method thereof.

2. Description of the Related Art

Currently, a variety of information presenting devices, such as a personal computer, a car navigation system, a personal digital assistant (PDA), etc., are used and among them there are some devices the presenting method of which have been devised.

For example, the information presenting device disclosed in Japanese Patent Laid-open No. 9-81099 (Japanese Patent Application No. 7-231044) comprises means for attaching priority to information, means for judging importance according to the interest of a user, etc., The information presenting device determines both the display order of information and the detailedness of each information, based on these items of information, and displays information. The information presenting device further comprises means for controlling the timing of collecting information from a network.

Other technologies for obtaining appropriate information from a great amount of information are as follows.

(1) Push technology: a technology for transmitting user's favorite information from a server

(2) Information filtering: a technology for selecting user's favorite information from a plurality of items of information

(3) Agent technology: a technology for collecting information from a network according to user's taste

These technologies select information based on correlation information between user's taste and a keyword, etc.

However, the conventional information presenting technologies described above have the following problems.

Since the conventional information processing device does not display information before it receives an explicit request from a user, both the time and quantitative effects of presenting an appropriate amount of necessary information at a required time is not taken into consideration.

Besides information to which a user may refer, if required, there is important information that is reported when a user does not expect. Information required by a user can be categorized into two groups: one group that a user is always sure to obtain and the other that a user wants to obtain, if possible. Including the latter information, in most cases, the amount of information to be obtained becomes fairly large. Therefore, it is difficult to process full information.

Adopting the conventional information presenting device described above, a certain amount of information can be selected/discarded based on user's taste information. However, in this case, only the type of information to be received can be selected based on the category, but the total amount of information cannot be controlled. Therefore, in this case, if a user has a variety of tastes, a great amount of information is collected, and as a result, the user cannot read the full information.

The amount of information to be processed varies depending on an individual, and each individual should be provided with the amount of information that the individual can process. If too much information is provided, as a result, a part of the information cannot help but be left unread or be discarded.

However, since the necessity of information varies depending on a place, a time, situation, etc., both the situation where information should be presented and the timing at which information is provided are also very important.

One must take other actions than reading information. If too much time is spent reading information, time for other actions must be cut or the other actions must be neglected. If information is provided, one is tempted to read it and the current work is interrupted, which is also a problem.

Furthermore, from the viewpoint of an information provider, if information is provided when a user is busy with another work or he/she is absent, there is the possibility that the provided information may not be used.

### SUMMARY OF THE INVENTION

It is an object of the present invention to provide an information presenting device for a user effectively utilizing provided information and a method thereof.

According to the first aspect of the present invention, the information presenting device comprises an information amount adjustment device and an information presenting timing adjustment device.

The information amount adjustment device adjusts an amount of information to be presented and the information presenting timing adjustment device adjusts a timing of presenting information. 29. An information presenting device, comprising:

setting device setting a unit period information amount for indicating an amount of information to be presented during a unit time period; and

processing device performing a process for presenting information based on the unit period information amount. 30. An information presenting device, comprising:

information presenting timing adjustment device adjusting a timing of presenting information to a user's free time based on a user's behavior; and

processing device performing a process for presenting information at the adjusted timing.

### BRIEF DESCRIPTION OF DRAWINGS

FIG. 1 shows the basic configuration of the present invention.

FIG. 2 shows the configuration of the information presenting system.

FIG. 3 shows the automatic setting of a unit period acquisition information amount.

FIG. 4 shows information adjustment.

FIG. 5 shows the sequential adjustment of information amount.

FIG. 6 shows real-time information amount adjustment.

FIG. 7 shows both behavior monitoring and timing adjustment.

FIG. 8 shows examples of obtained information.

FIG. 9 is a flowchart showing the first information presenting process.

FIG. 10 shows the first schedule.

FIG. 11 shows the second schedule.

FIG. 12 is a flowchart showing the second information presenting process.

FIG. 13 shows the third schedule.

FIG. 14 shows the first system.

FIG. 15 shows the second system.

FIG. 16 shows the configuration of the information processing device.

FIG. 17 shows storage media.

### DESCRIPTION OF PREFERRED EMBODIMENTS

The preferred embodiments of the present invention are described in detail below with reference to the drawings.

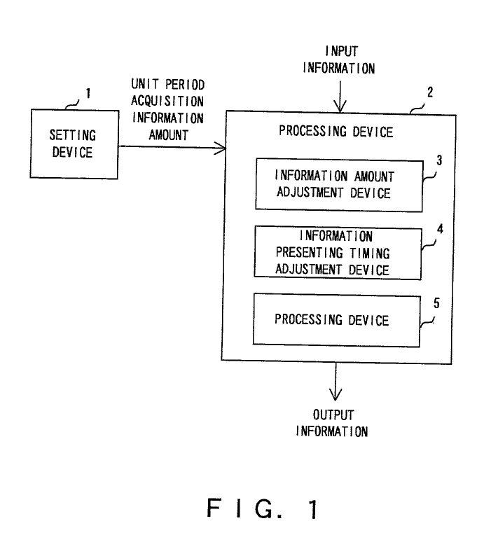

FIG. 1 shows the basic configuration of the information presenting device of the present invention. The information presenting device shown in FIG. 1 comprises setting device 1 and processing device 2. The processing device 2 includes information amount adjustment device 3, information presenting timing adjustment device 4 and processing device 5.

According to the first principle of the present invention, the information presenting device comprises information amount adjustment device 3 and information presenting timing adjustment device 4. The information amount adjustment device 3 adjusts the amount of information to be presented, and the information presenting timing adjustment device 4 adjusts a timing of presenting information.

Since the information amount adjustment device 3 adjusts the amount of information to be presented to a user and the information presenting timing adjustment device 4 adjusts a presenting timing to the user, the user can receive an appropriate amount of information at an appropriate timing.

According to the second principle of the present invention, the information presenting device comprises setting device 1 and processing device 2. The setting device 1 sets unit period acquisition information amount for indicating the amount of information to be presented during a unit time period, and the processing device 2 presents information based on the unit period acquisition information amount.

A unit period acquisition information amount is the amount of information to be presented to a user during a specific unit time period. The amount is inputted by a user, is provided in the device in advance or is automatically set. The processing device 2, for example, adjusts information using the set unit period acquisition information amount and outputs the adjusted information. In this case, there are two cases: one case where information is outputted from an output device and is directly presented to a user and the other case where information is outputted to a communications network and is transmitted to a user terminal via the network.

The processing device 2 can also output both original information and information for designating how to adjust the information to an outside device instead of adjusted information. In this case, the outside device adjust the information and present the information to a user.

For example, if the processing device 2 includes an information amount adjustment device 3, the information amount adjustment device 3 adjusts the amount of information to be presented to a unit period acquisition information amount. If the processing device 2 includes an information presenting timing adjustment device 4, the information presenting timing adjustment device 4 distributes the unit period acquisition information amount during a unit time period.

By setting a unit period acquisition information amount and adjusting information amount to the information amount, a user can receive an appropriate amount of information at an appropriate timing.

According to the third principle of the present invention, the information presenting device comprises information presenting timing adjustment device 4 and processing device 5. The information presenting timing device 4 adjusts a timing of presenting information to a user's free time, and the processing device 5 presents the information at an adjusted timing.

User's behaviors can be monitored using the operation status of the device, a camera or a variety of sensors, and a user's free time can be estimated from the obtained information. A user's free time is free time when a user can read information. For example, the information presenting timing adjustment device 4 generates a schedule to present information during this free time, and the processing device 5 outputs information according to the schedule.

In this way, by presenting information according to a user's free time, there becomes little possibility that user's work may be interrupted or a user may overlook information.

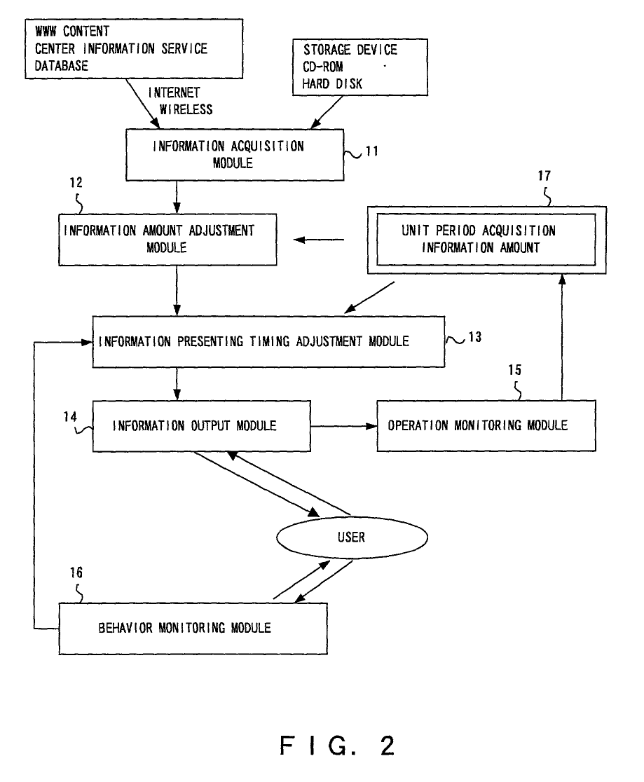

For example, the setting device 1, information amount adjustment device 3, information presenting timing adjustment device 4 and processing device 5 shown in FIG. 1 correspond to the operation monitoring module 15, information amount adjustment module 12, information presenting timing adjustment module 13 and information output module 14, respectively, shown in FIG. 2 described later.

In a preferred embodiment, an appropriate amount of information can be presented by adjusting an amount of information to be presented to a user during each unit time period and judging an appropriate information presenting timing based on user's a behavior, etc. In this way, a user can collect appropriate information and also can smoothly do other pieces of work than information collection. Collected information can also be effectively utilized. For the information presenting form to a user, an arbitrary form, such as text, images, video, audio, etc., can be used.

The information presenting device of this preferred embodiment includes an arbitrary device for presenting information. For example, the information presenting device includes a personal computer, a mailer, a screen (desktop, screen saver or Web page), a car navigation system, a personal digital assistant (PDA), a cellular phone, a PHS (personal handy-phone system), a pager (pocket bell), an electronic advertisement tower (in a street, train, bus or taxi), a TV set, a radio set, a Web TV set, the operation panel of a large system and a POP (point of purchase) terminal.

The information presenting device of this preferred embodiment can also be used in an information collection device, such as a video recorder, a home server, a database, etc., advertisement system and a learning system.

FIG. 2 shows the configuration of the information presenting system of the present invention. The information presenting system shown in FIG. 2 comprises an information acquisition module 11, an information amount adjustment module 12, an information presenting timing adjustment module 13, an information output module 14, an operation monitoring module 15 and a behavior monitoring module 16.

The information acquisition module 11 obtains information required by a user, information transmitted without leave, etc. The information amount adjustment module 12 sets an information amount 17 during each unit time period that a user receive (unit period acquisition information amount) and adjusts an obtained information amount in order to transmit an appropriate amount of information to the user.

The unit period acquisition information amount 17 can be set in either a manual mode or automatic setting mode. In the manual mode, an information amount designated by a user or an information amount set in advance by a system designer is set as a unit period acquisition information amount 17. In the automatic setting mode, the operation monitoring module 15 monitors user's input operation via the information output module 14 and generates a record on information that a user actually accesses. Then, the operation monitoring module 15 automatically adjusts a unit period acquisition information amount 17 based on the record.

The behavior monitoring module 16 monitors user's a behavior, and the information presenting timing adjustment module 13 judges an appropriate information presenting timing to the user based on correlation between a user's behavior and information priority, etc. The behavior monitoring module 16 also adjusts the timing depending on the content of information, etc., in order to effectively present information. The information output module 14 presents information to the user at the timing set in this way.

Next, the operation of each module is described in detail. First, the information acquisition module 11 obtains information from a variety of information sources. For the information source (acquisition form), E-mail, electronic news, a mail magazine, a pocket bell distribution system, a radio teletext system, automatic collection from the Internet by an agent, a WWW (world wide web) content, a center information service, an access to a database, a storage device, a storage medium, such as a CD-ROM (compact disk read-only memory), a hard disk, etc., can be used.

Acquisition information includes news (political/economic/international, social/cultural/entertainment, sports, technological), movie information, gourmet information, traffic information, a list of TV programs, stock market information, weather information, horoscope information, event information, learning information (word memorization service), mail from a friend, contact from an office, emergency contact at the time of disaster, a circulation board, questionnaires, an advertisement, a government service, a missing announcement, real estate information, the live broadcasting of an event, such as sports, etc., reading recommendation, a menu service, a balance inquiry, help information, self-governing body information, location information of a friend, a time table, routing information, a software operation method, etc.

Since a unit period acquisition information amount is an information amount obtained during a unit time period , it can be expressed as I/T if a unit time period and an information amount obtained during the time period are assumed to be I and T, respectively. This unit period acquisition information amount is also used as an information amount to be presented to a user during a unit time period, as described later.

For example, if 30 units of information are obtained per day, the unit period acquisition information amount is expressed as 30 units/day. This unit period acquisition information amount can be also set widely like 200 units/week or 1,000 units/month for a user who frequently travels on business. Conversely, it can also set finely like ten units/two hours for a user whose time management is tight, such as a salesperson, manager, etc. Furthermore, if a specific predetermined time can be set like a travel time on a train or car, an information amount to be read during the travel time can also be set as a unit period acquisition information amount.

In this case, the unit of an information amount indicates a measure used to separate information. Usually, one unit of information amount corresponds to one article of news or one item of mail. If there are differences in size between a plurality of items of information, a unit information amount can also be determined using the number of bytes, number of characters, number of sentences, etc.

Furthermore, when hardware used to present information is determined, an amount that can be displayed on the screen of the hardware (for example, one screen page of a pager) can be used as one unit. Alternatively, if information is read loud, an amount that can be outputted during a specific time period (for example, 30 seconds) can be set as one unit. In the following description, one unit of information amount maybe counted as one item for convenience' sake.

As described above, in the manual mode, a user can set a unit period acquisition information amount. For example, a user can determine to receive only 30 items/day of news or to receive only the same information amount per day as that of a piece of general newspaper.

In the automatic setting mode, the operation monitoring module 15 automatically judges an information amount during a unit time period based on a user's behavior (operation) history and set the amount as his/her unit period acquisition information amount. For example, the operation monitoring module 15 measures specific times an information amount accessed by a user during a unit time period in the past, and automatically sets the amount as his/her unit period acquisition information amount.

In this case, to access information means not only to confirm that the information has been obtained, but also to actually read (or listen to) the content of the information. Whether a user has accessed information is judged using an operation history indicating that the user has viewed a list of titles, has selected a specific title and has displayed the entire content of the information on the screen or an operation history indicating that the information has been displayed over a specific time.

For example, if it is detected from such a past record that the user has read 20 items of news articles per day, he/she is judged to be able to read 20 items per day and his/her unit period acquisition information amount is set to 20 items/day. After this time, an information amount presented to the user per day is restricted to 20 items or less.

Furthermore, the unit period acquisition information amount of one user can be fixed constant or can be expressed with a function with an input condition such that the value varies depending on conditions, such as the day of a week, a time zone, etc. A unit period acquisition information amount can be set to, for example, 20 items/day for a week day and 5 items/day for holidays, or 10 items/hour for the morning, 5 items/hour for the afternoon and 3 items/6 hours for midnight, or the unit period acquisition information amount at time t can be expressed with a function f(t).

In this way, an information amount suitable for a user's process speed can be presented by setting a unit period acquisition information amount based on a user's behavior history.

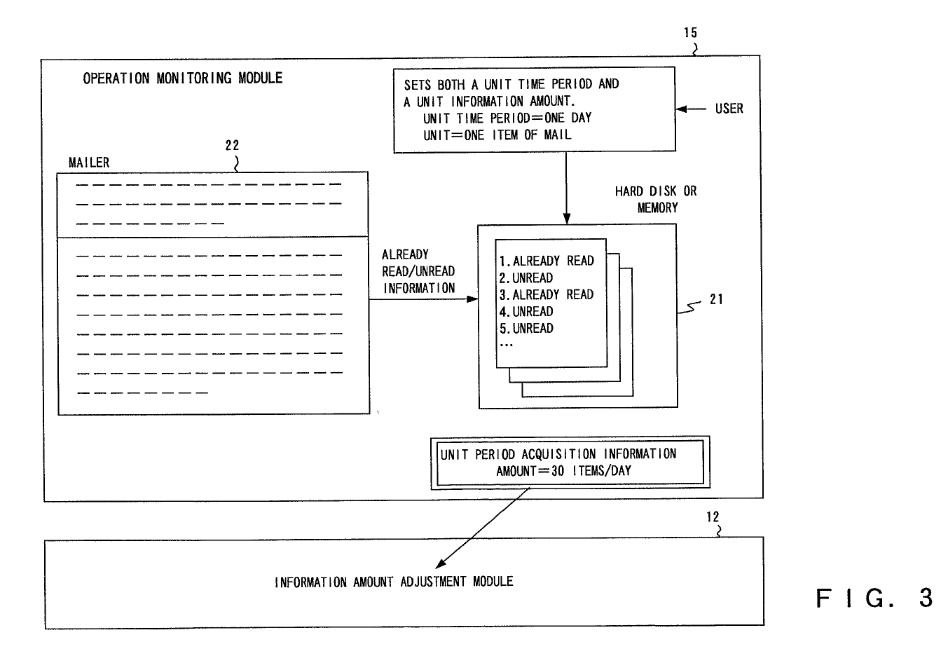

FIG. 3 shows an example of the operation in the automatic setting mode. In order to automatically set a unit period acquisition information amount, it is necessary to record an information amount read by a user at least over a unit time period. For that purpose, the user sets both a unit time period and a unit information amount in a storage device 21 (a hard disk, a memory, etc.). In this example, one day and a piece of mail are set as the unit time period and unit information amount, respectively. Alternatively, a default value inputted in advance in the operation monitoring module 15 can be used.

Then, the operation monitoring module 15 records an information amount read by the user during each unit time period, in the storage device 21. In this example, data (already read/unread) indicating whether the user has read mail obtained by a mailer 22 are recorded for each mail. Then, the operation monitoring module 15 repeats this operation a plurality of times in order to eliminate differences in value and to improve accuracy, and determines his/her unit period acquisition information amount based on the average or dispersion of the data. In this example, his/her unit period acquisition information amount is set to 30 items of items/day.

The unit period acquisition information amount set in this way is transferred to the information amount adjustment module 12 and is used to adjust the information amount to be presented to a user. In this way, the user can be released from troubles of selecting necessary information from a great amount of extra information. Besides, since the unit period acquisition information amount is suitable for the user's process capability, the information can be just processed (read) during the unit time period.

If the read amount of information is recorded separately for each of a variety of attributes when the information is read, a unit period acquisition information amount can be set for each attribute. For example, if an information source is mail, the read amount can be recorded for each sender (information source) or can be recorded for each folder prepared by the user. If the user reads information using a variety of hardware or software, the read amount can also be recorded for each of the tools. In the case of software without such a classification function, such as a mailer 22, already read/unread data can be recorded while categorizing information using keywords or correlation information.

Furthermore, by applying a data mining method, etc., to information read by the user, more refined classification is also available. Alternatively, information with an attribute originally attached can be recorded for each attribute. A unit period acquisition information amount can be set based on the information amount collected for each attribute in this way during a unit time period.

Then, the information amount adjustment module 12 adjusts an information amount obtained by the information acquisition module 11 in such a way that an information amount presented to a user may equal his/her set unit period acquisition information amount.

As the adjustment method of an information amount, for example, there is a method for deleting extra information exceeding a unit period acquisition information amount. According to this method, if an information amount obtained by the information acquisition module 11 is greater than the unit period acquisition information amount, the information is sorted according to importance combined with priority and a user's taste (interest), and information located within a specific tolerance is sequentially presented. Then, the remaining unread information is deleted.

The size of each item of information can also be reduced. According to this method, one of only the titles, only the summaries and only the full text of information can be automatically selected based on priority or importance, and an information amount to be presented is adjusted to be a unit period acquisition information amount or less. Furthermore, the information amount to be presented can be adjusted based on the classification between information that must be presented in any situation and information that can be deleted.

If the information amount obtained by the information acquisition module 11 is less than a unit period acquisition information amount, the information acquisition module 11 positively collects the shortage of the information. For example, information can be searched for on the Internet based on a user's taste and a keyword using an agent technology.

Although in the description given above, a system in which information is automatically transmitted, is mainly presumed, in the case of a system which is connected only to a hard disk that is not connected to a network, information is extracted from the hard disk in accordance with the unit period acquisition information amount and is presented to a user. For example, a learning system for presenting English teaching materials recorded in a CD-ROM corresponds to this.

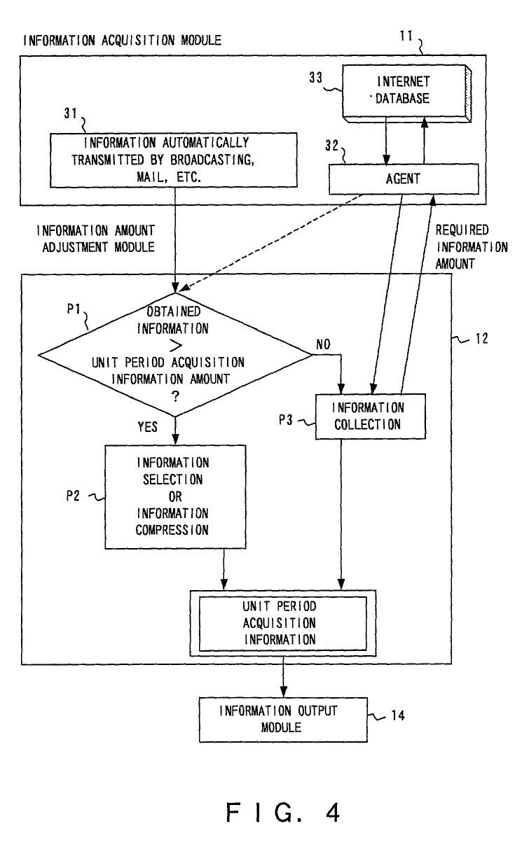

FIG. 4 shows an operation example of information amount adjustment. The information acquisition module 11 is connected to a wired or wireless network, or has a function to receive broadcast information, such as broadcasting, etc., and the module 11 obtains a great amount of information. Then, the module 11 has a storage device for storing the obtained information until the information is presented to a user.

Information obtained by the information acquisition module 11 includes information 31 that can be automatically received, such as information transmitted from a broadcasting station, mail, etc., and information that an agent 32, etc., collects from an information source, such as the internet, a database, etc. The agent 32 automatically collects information required by a user using a keyword for a user's taste, a rule base, correlation information, etc.

The information amount adjustment module 12 compares the amount of such obtained information with a unit period acquisition information amount (process Pl). If the obtained information amount is greater than the unit period acquisition information amount, the module 12 performs the selection or compression of the information (process P2) and adjusts the information amount to the unit period acquisition information amount. Conversely, if the obtained information amount is less than the unit period acquisition information amount, the module 12 notifies the agent 32 of the information shortage and requests the agent 32 to collect the information shortage (process P3). Then, the module 12 adjusts the information amount to the unit period acquisition information amount.

If the obtained information amount is adjusted to the unit period acquisition information amount in this way, the information amount adjustment module 12 transfers the unit period acquisition information to the information presenting timing adjustment module 13 or information output module 14.

Here, the determination methods of both importance and priority used to adjust an information amount are described. Importance is an index for indicating a degree up to which a user is required to know the information and largely depends on the position and taste of a user. This index indicates the degree of reading necessity, such as a situation where a user must read the information, a situation where it is better for a user to read the information, if possible, a situation where there is no problem in a user not reading the information, but he/she wants to read when he/she has time to read, etc.

Priority is a relative index for indicating the reading necessity of the information in comparison with other items of information. This index indicates the degree of reading necessity in comparison with other pieces of information, such as a situation where a user must read the information before any other items of information, a situation where it is better for a user to read the information if there is no other information, etc. This index is also used to determine the presenting order of a plurality of items of information.

As to the determination method of importance, for example, if a keyword for a user's taste is known, importance based on the user's interest can be set based on the keyword. If the keyword is unknown, importance can be automatically judged from a user's information reading history. Instead of the user-based importance, importance can also be set using an absolute index. For example, information put on the top page of newspaper can be judged to be absolutely important.

As to the determination method of priority, priority can be given based on the emergency of each item of information. In this case, top priority is given to emergency information. Alternatively, priority can be given to a specific field. In this case, the information about the specific field has priority over the information about other fields. Priority can also be modified based on the reliability of an information source or based on the transmitting medium or transmitting method of an information source.

In this way, for example, electronic mail can have priority over news, information about a computer can have priority over information about sports, or information from a news agency can have priority over information from another information source. If the presenting order of information has a meaning, a specific item of information can also be presented before other items of information using priority.

Such adjustment methods of information amount using importance or priority can be largely categorized into two groups: subsequent information amount adjustment and real-time information amount adjustment. For example, if a real-time indication tag is attached to information, real-time information amount adjustment is made. Otherwise, sequential information amount adjustment is made. The real-time indication tag is attached by an information provider or a user.

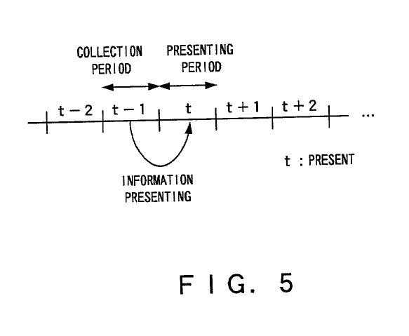

FIG. 5 shows an example of sequential information amount adjustment. According to this method, in order to present information to a user during a unit time period t, the information acquisition module 11 collects information and the information amount adjustment module 12 adjusts the information amount during or before the immediately previous time period t−1. Then, during time period t, both the information presenting timing adjustment module 13 and information output module 14 present the information to the user. In this case, the adjustment method is the same as a news editing mechanism where news collected by the previous day is edited to be accommodated into the following day's newspaper.

If the information collected during time period t is desired to be presented in real time during the time period, real-time information amount adjustment is made. According to this method, a part of the unit period acquisition information amount collected during time period t−1 is replaced with information desired to be presented, based on an attribute, such as importance, priority, must, etc. In this case, the replacement of the information collected during time period t−1 is deleted like the other information already deleted during time period t−1. If the information is must information and must be presented to a user without fail, the information can be presented during the subsequent presenting period t+1 and after.

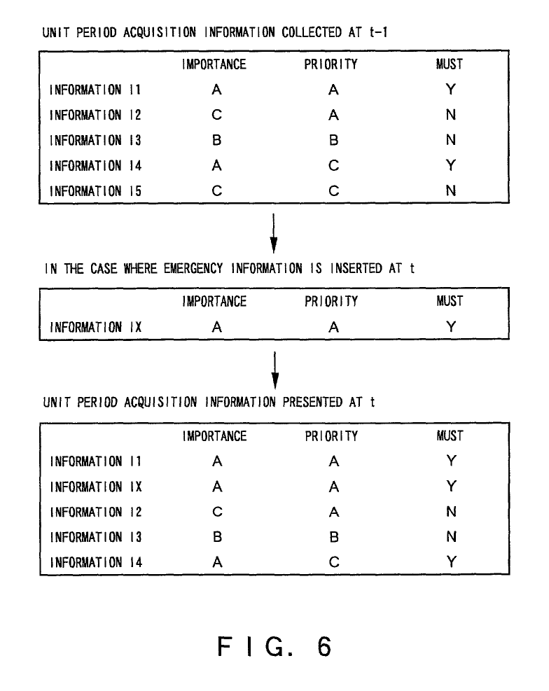

FIG. 6 shows an operation example of such real-time information amount adjustment. In this example, a plurality pieces of information Il, I2, I3, I4 and I5 are collected and a list of items of information to be presented during time period t is generated during time period t−1. In this list, an information presenting order is determined based on each attribute of importance (A/B/C), priority (A/B/C) and must (Y/N).

If during time period t, emergency information IX is received before the presenting of information is started, the information is inserted between information I1 and information I2, and instead, information I5 is deleted from the list. However, if the information I5 is a must, the information I5 is not deleted and is added to a list of items of presented information during the subsequent time period t+1.

If during time period t, emergency information IX is received after the presenting of information is started, it is considered that several items of information are already displayed. In this case, the remaining items of information and the information IX are compared and their presenting orders, etc., are adjusted.

Then, the information presenting timing adjustment module 13 adjusts the timing of presenting the information to a user based on information obtained from the behavior monitoring module 16. The behavior monitoring module 16 estimates a user's behavior based on both information obtained by a camera or a variety of sensors and the operation histories of a variety of devices. The information presenting timing adjustment module 13 determines whether this is a timing of presenting information or how long the information should be presented based on the user's behavior.

The information presenting timing adjustment module 13 is largely categorized into the following three groups.

(I) A module for distributing information during the unit time period

(II) A module for choosing a user's free time and presenting information

(III) A module for adjusting a timing in such a way that the attribute, such as the content, etc., of information can match the situation at the time of presenting the information.

Of these, only module (I) performs a process related to a unit period acquisition information amount, modules (II) and (III) can perform a process regardless of the unit period acquisition information amount. Of these processes, arbitrary ones can also be incorporated into one module.

Module (I) distributes information of the unit period acquisition information amount among a plurality of time zones in the unit time period, which are designated by a user. In the automatic distribution mode, data about how much information a user reads in which time zone are recorded from a user's reading history, using the same method as that adopted in the automatic setting mode of the unit period acquisition information amount shown in FIG. 3 and module (I) appropriately distributes the information based on the data. Furthermore, the module (I) also determines an information presenting order based on an attribute, such as importance, priority, must, etc., that information already has or processes real-time information, such as emergency information, etc.

In order to implement the process of modules (II) and (III), information from the behavior monitoring module 16 or similar information must be obtained by communications, etc.

Module (II) chooses a user's free time and presents information regardless of the content of information to be presented. If the main job of a user is not to read information, the module adjusts an information presenting timing in such a way to present information when the user is released from his/her main job.

For example, in the case of a car navigation system installed in a car, information is presented when the car stops. Whether a car stops or not is judged from the fact that the value of an accelerometer is 0, that a gear is put in P (parking), the state of a brake, etc., or is judged using a global positioning system (GPS).

It is also considered to be good from the viewpoint of safety that information is presented when a car stops. In this way, a user (driver) can concentrate his/her attention on driving when he/she drives and can read information when the car stops and he/she is free. Even if information could be presented by speech synthesis, there would be the possibility that the user may fail to catch the information if information not related to driving is presented while driving the car. It is also well known that many accidents are caused if a user communicates over cellular phone while driving a car.

Similarly, in the case of a PDA, information is also presented when a user does not walk. Whether the user walks or not is judged using a GPS, accelerometer, etc. In the case of a cellular phone, information is also presented when a user does not walk or when a user does not use the cellular phone for communications, etc. For this reason, a function to prohibit a user from reading information while walking, etc., is provided into a PDA.

In the case of computer, how busy a user is judged based on the number of other running application software programs, the state of use of a memory, the operation time of a terminal, etc. It is also effective to set a criterion where if a user uses one application software program for a long time, he/she is regarded to be absorbed in some work. A user's free time is chosen based on these items of information and information is presented during the free time. However, the system can also be set in such a way that emergency information can be presented regardless of whether a user is free or not.

Module (III) presents information in such a way that the content of information to be presented or another attribute can match an environmental situation obtained from the behavior monitoring module 16. The behavior monitoring module 16 notifies this information presenting timing adjustment module 13 of information about both a user and an environmental situation. The information presenting timing adjustment module 13 distributes information of a unit period acquisition information amount in such a way that information can be effectively transmitted for the user or a sender.

It is assumed that an information group to be presented to a user is already determined by the information amount adjustment module 12 and the information presenting timing adjustment module 13 simply determine both the presenting timing and order of each item of information. In this case, the information presenting timing adjustment module 13 has a rule base for adjusting the content of information and presents information in such a way that the conditions of the rule base can be met as much as possible.

The rule base stores, for example, the following rules.

(1) Information about the neighborhood of a user's current location is presented.

(2) Before meal, information about restaurants located near a user is presented.

(3) In the morning, news is presented.

For example, if there is a pieces of news, an advertisement of a restaurant, an advertisement of a store and a pieces of mail from a friend, the presenting timing of each of the plurality of items of information is adjusted based on the conditions of the rule base and the plurality of items of information are displayed. In this case, as information to be presented, the news is displayed in the morning, the advertisement of a restaurant is before lunch, the advertisement of a store is displayed when a user is near the store. The presenting timing of information that does not meet any of the condition is adjusted by another method and the information is displayed during a unit time period.

If a user dines at a restaurant, the information presenting device judges which is an appropriate timing, before meal, during meal, before dessert, after meal, when the user pays for meal at the cashier, and presents information. In this case, the display medium is a user's PDA or a restaurant's display screen.

For example, the regular menu of the restaurant is displayed before meal, information about movie houses, lodging facilities, etc., as the guidance of places visited after meal is displayed after meal, and information about both the fringe benefits for the next visit to the restaurant and service events in the future (cake buffet, etc.) is displayed at the cashier. In this way, by presenting information at an appropriate timing, the effect of information is improved and both a sender and a receiver are benefited.

If it is not determined yet which item of information of many and unspecified items of information should be presented, the information presenting timing adjustment module 13 adjusts and sequentially presents information according to the rules of the rule base. In this case, when the amount finally reaches a unit period acquisition information amount, information presenting finishes. Alternatively, the information presenting timing adjustment module 13 simply modifies the priority of information, etc., and the final adjustment of an information amount can be assigned to the information amount adjustment module 12.

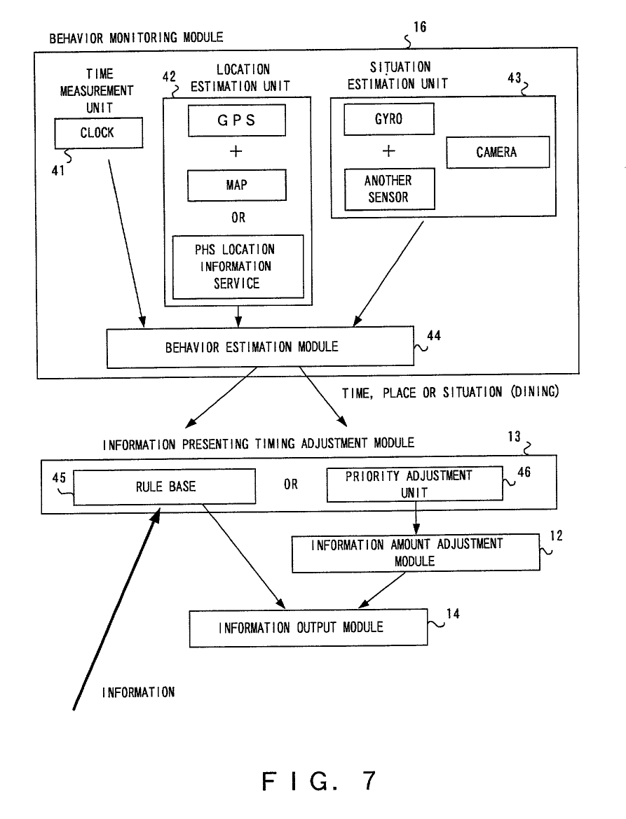

FIG. 7 shows an operation example of both behavior monitoring and timing adjustment. The behavior monitoring module 16 shown in FIG. 7 includes a time measurement unit 41, a place estimation unit 42 and a situation estimation unit 43 and a behavior estimation module 44, the information presenting timing adjustment module 13 includes a rule base 45 and a priority adjustment unit 46.

As described above, the rule base 45 stores rules for selecting information based on both the behavior and situation of a user, and the information presenting timing adjustment module 13 adjusts an information amount to be transferred to the information output module 14 according to the rules. As described above, the priority adjustment unit 46 modifies information priority, if required, and requests the information amount adjustment module 12 to adjust an information amount.

The time measurement unit 41 of the behavior monitoring module 16 includes a clock in order to measure time as the most basic monitoring target. If there is rules based on time, the information presenting timing adjustment module 13 presents information according to the rules based on the measured time. In this case, no other special function is required. For example, the rules based on time are as follows.

(1) If it is 7 AM, then weather information is presented.

(2) If it is between 11 and 12 AM, then restaurant information is presented.

The place estimation unit 42 obtains place information as the second basic monitoring target. This place information can be obtained using a GPS and a map matching function or the location information service of PHS. What can be obtained from a GPS is a simple longitude/latitude information. Therefore, if rules, including the name of town and the name of a store are used, the longitude/latitude information and the name of the town, etc., must be matched. Since a map software program usually includes such a function, it can be used.

The information presenting timing adjustment module 13 presents information according to rules based on a place estimated by the place estimation unit 42. For example, the rules based on a place are as follows.

(1) If the longitude and latitude are 36. 2. 5 and 133. 33. 36, respectively, then the timetable of Tokyo station is presented.

(2) If a user is located in department store A, then the bargain sales information of department store A is presented.

The situation estimation unit 43 obtains various categories of information about a user's behavior and an environmental situation by using a variety of sensors, such as an acceleration sensor, a gyro sensor, etc., analyzing image information obtained from a camera or receiving information already obtained by an outside device sensing. The information presenting timing adjustment module 13 presents information according to rules based on a situation estimated by the situation estimation unit 43. For example, the rule based on a situation is as follows.

If the value of an acceleration sensor>100, then warning information about speed is presented.

Furthermore, the behavior estimation module 44 can also estimate a user's behavior based on information obtained from the time measurement unit 41, place estimation unit 42 and situation estimation unit 43, and can also transfer the estimation result to the information presenting timing adjustment module 13. The behavior estimation module 44 includes, for example, a rule base for storing the following rule and estimates the user's behavior according to the rule.

If a user stays in a location of a restaurant for a specific time, then he/she is dining.

The behavior estimation module 44 can also estimate a behavior using a user's gesture recognized from the image information of a camera.

In this case, the conditions of a rule stored in the rule base 45 of the information presenting timing adjustment module 13 indicate categories of a behavior. For example, the rule based on the category of behavior is as follows.

If a user is dining, then information about the additional menus of the restaurant is presented.

The behavior estimation module 44 can also estimate not only a user's behavior, but also a variety of situations based on information obtained from the time measurement unit 41, place estimation unit 42 and situation estimation unit 43. For example, if weather is estimated in a car, the following rules are used.

(1) If the humidity is high, then it rains.

(2) If the humidity is normal, then it is cloudy.

(3) If the humidity is low, then it is clear.

(4) If a wiper is swinging, then it rains.

(5) If a fog lamp is lit, then it is smoggy.

(6) If the brake does not work well, then it rains.

Besides, an environmental situation can be estimated from relationship between a time period during which a driver puts his/her foot on the brake and the distance driven during the time period, relationship between the rotated angle/speed of the steering wheel at a curve and a gyro, the information of an acceleration sensor, gyro, road sensor, etc., sensor information from an infrastructure on the road, information obtained by communications with an outside information source, such as the Internet, etc.

However, there is a case where although it is known that the rules of the rule base 45 hold true, information designated after “then” does not correspond to the content of each item of information. In this case, information corresponding to the designated information must be selected.

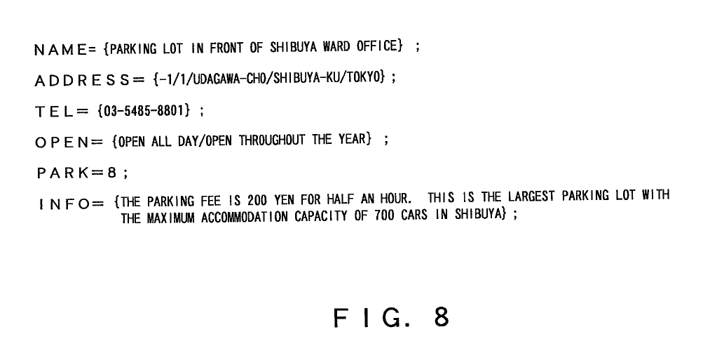

If each item of information is explicitly expressed with such as a place, a category, etc., as shown in FIG. 8, information to be presented is selected according to the expression. Otherwise, keyword search is automatically conducted for a sentence or a title, and appropriate information is searched for and presented. If each item of information is categorized in advance, appropriate information can be obtained by tracking the category.

The behavior monitoring module 16 need not necessarily be installed in the information presenting device. In that case, the information presenting device can also receive information about user's a behavior from an outside device by communicating with it. Furthermore, the setting of the information amount adjustment module 12 can also be modified based on information obtained from the behavior monitoring module 16, and the information amount can also be adjusted based on the user's behavior.

As described above, the configuration shown in FIG. 7 requires a variety of rules. The method for setting those rules are as follows.

(1) The rules are incorporated in advance into the system.

(2) A user sets the rules.

(3) The rules are downloaded from another system

(4) The system automatically generates the rules.

Of these, the automatic generation in (4) can be implemented by a technology disclosed in prior Japanese Patent Application “Action Proposal/Execution Device by Procedure Database with Automatic Procedure Function and Procedure Database Storage Recording Medium Using It” (Japanese Patent Application No. 10-024113).

As the notation of the rules, besides a method of describing the rules using a user's situation or an environmental situation as a condition (criterion), there is a method of describing the rules using information as a condition.

(1) If the information is weather information, then it is presented in the morning.

(2) If the information is restaurant information, then it is presented at lunch or dinner time.

Furthermore, the relationship between the behavior and situation of a user and information to be presented can also be anticipated based on correlation, can be estimated based on probability (Bayesian inference) or can be expressed with a network, instead of the if-then rule.

The information presenting timing adjustment module 13 sometimes adjusts a timing based on another attribute of information in addition to the content of information. For example, timing can also be adjusted based on the size of each item of information. It is assumed that of a plurality of items of information II, I2, I3 and I4, the sizes of II and I4 are small, that of I2 is large and that of I3 is middle. In this case, a timing is adjusted in such away that information I2 can be displayed if a user views information with a personal computer on the desk and information I1 or I4 can be displayed if a user views information with a PDA out of the office.

Such adjustment is effective if the unit information amount is determined without being based on the size of each items of information like a piece of mail. However, if the unit information amount is determined based on an information size as in information of 1K byte, timing is adjusted based on the restriction of hardware outputting information. For example, if an output screen is large, information of large size is displayed; and if the screen is small, information of small size is displayed.

Furthermore, the module 13 can also be adjusted in such a way that if a user's free time is long, information of large size can be presented; and if a user's free time is short, information of small size can be presented.

The other examples of use of the information presenting timing adjustment module 13 are as follows.

(1) Information, such as the timetable or departure/arrival time of traffic facilities, etc., is presented while a user leaves for a station, an airport, etc.

(2) Weather information is presented when a user goes out.

(3) Information about a facility is presented when a user comes near the facility.

(4) Information about a gas station is presented when the gas of a car runs short.

(5) Information is displayed on the screen of a terminal at a street corner only when there is a person before the terminal.

Conversely, information should not be presented when a user is located in a hospital, when an airplane takes off or lands, when a user is located in a concert hall, when a user gets on a train, etc. If a radio wave is emitted in a hospital or at the time of the taking off/landing of an airplane, there is the possibility that a medical instrument or a meter may operate wrongly. A voice raised in a concert hall or in a train is a nuisance to other people. Therefore, in such a case, the presenting of information is prohibited by the information presenting timing adjustment module 13.

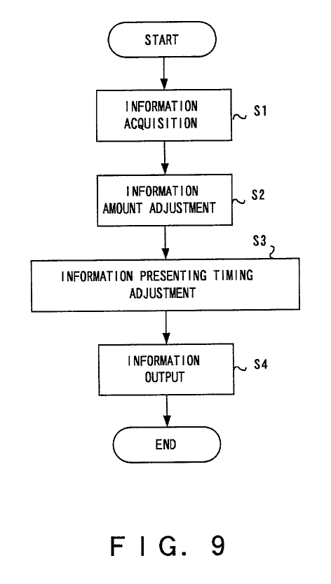

FIG. 9 is a flowchart showing the process of the information presenting system shown in FIG. 2. First, the information acquisition module 11 obtains information (step S1), and the information amount adjustment 12 adjusts the information amount (step S2). Then, the information presenting timing adjustment module 13 adjusts a timing (step S3), information output module 14 outputs the information (step S4) and the process is terminated.

In this case, a unit period acquisition information amount is predetermined, and it is scheduled in such a way that the information presenting timing adjustment module 13 presents information at an appropriate timing after the information amount adjustment module 12 determines the content of information.

For example, if a unit period acquisition information amount is 30 items/day, first, the information amount adjustment module 12 adjusts information amount per day to 30 items, adjusts a timing, such as in the morning, noon, after a user is absorbed in a work and is tired out, etc., in such a way that all of 30 items can be presented in a day. If 10 items must be presented while a user is travelling by car, a few items are sequentially presented at each traffic signal stop.

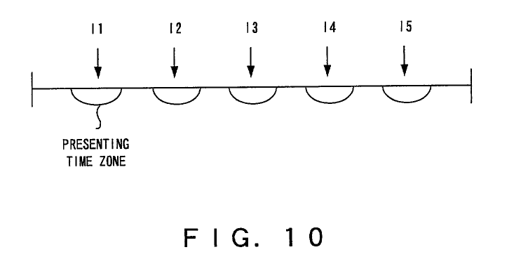

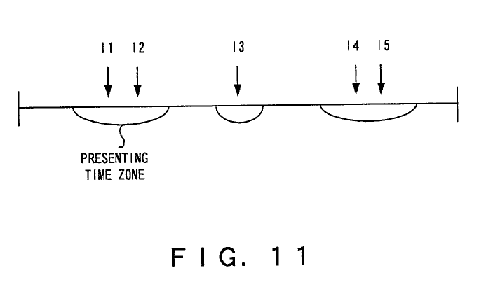

Next, it is assumed that a unit period acquisition information amount is five items/day, the information acquisition module 11 obtains 50 items of information and the information amount adjustment module 12 narrows the 50 items of information to five items of information I1, I2, I3, I4 and I5. In this case, the information presenting timing adjustment module 13 schedules the information presenting, for example, as shown in FIG. 10 or 11.

In FIG. 10, information is equally distributed among presenting time zones; and in FIG. 11, the maximum number of items for each time zone are sequentially distributed to each time zone in presenting order. In this case, each presenting time zone corresponds to a time zone designated by a user or a time zone when it is estimated that a user will be free.

The information presenting timing adjustment module 13 can also appropriately schedule information presenting according to the content of information, etc. In this case, timing is conformed to a schedule designated by a user, is conformed to the importance, priority or a user's schedule, or the size of a file is selected depending on a user terminal.

In the information presenting system shown in FIG. 2, the system is configured in such a way that the information presenting timing adjustment module 13 adjust timing after the information amount adjustment module 12 adjusts an information amount. However, the processing order can also be reversed by reversing the allocation of these modules.

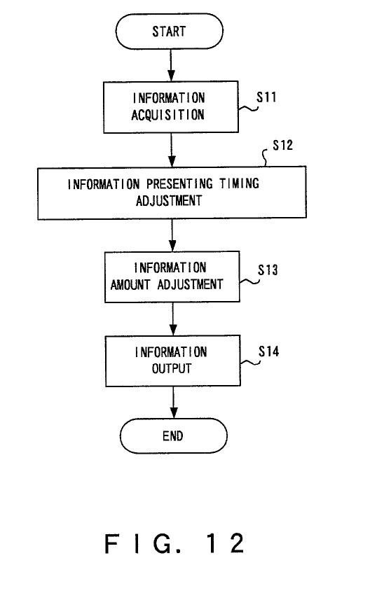

FIG. 12 is a flowchart showing the process such an information presenting system. First, the information acquisition module 11 obtains information (step S11), and the information presenting timing adjustment module 13 adjusts a timing (step S12). Then, the information amount adjustment module 12 adjusts the information amount (step S13), the information output module 14 outputs information (step S14) and the process is terminated.

In this case, after the information presenting timing adjustment module 13 secures presenting time zones, the information amount adjustment module 12 adjusts an information amount for each time zone in such a way to present a unit period acquisition information amount. If the number of time zones in which information can be presented during the unit time period and relative length of each time zone can be judged from the history, the unit period acquisition information amount is set in such a way to be presented in such time zones.

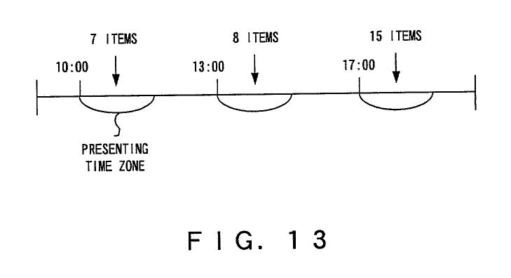

For example, it is assumed that a unit period acquisition information amount is 30 items/day, the number of timings of presenting information is three of 10:00, 13:00 and 17:00 and of these, it is known that the best timing of a user's reading information is a timing of 17:00. In this case, the information presenting timing adjustment module 13 schedules information presenting in such a way that seven items, eight items and 15 items of information can be presented at 10:00, 13:00 and 17:00, respectively, as shown in FIG. 13.

If the information acquisition module 11 obtains 100 items of information, the information amount adjustment module 12 selects the predetermined number of items of information, the contents of which are conformed to each set timing, and distributes the information among timings. In this way, 30 items/day of information are selected and presented to a user.

In this way, the information amount adjustment module 12 and the information presenting timing adjustment module 13 have close relation and substantially adjust information while cooperating. In particular, in the case of real-time information amount adjustment shown in FIG. 6, a very close operation process is required.

Next, a case where a unit period acquisition information amount, an information amount adjustment method and information presenting timing are set for each of a variety of attributes is described. Here, description is given using an example for each information category. If information is categorized as follows, both a unit period acquisition information amount and an information presenting timing can be set taking into consideration the importance and priority of each category.

(1) Entertainment information from a store, a restaurant, etc. (advertisement)

(2) News (general, technology)

(3) Sports news (result)

(4) Live broadcasting (sports, music)

(5) Learning information (language, examination)

(6) Driving emergency information

(7) Driving supplementary information

(8) Mail from a friend (emergency, notification, chat)

(9) Real-time chat

For example, although inmost cases, the deletion of information (8) causes a trouble, display timing depends on the emergency degree. It is meaningless if information (1) is not used on the spot. Therefore, if timing is missed, the information can be deleted. Although information (5) can be presented in a user's free time, it must be somewhat regularly and sequentially presented. In this way, the setting of the information presenting system is modified depending on a category.

Furthermore, the system can also be configured in such a way that such setting can also be modified for each receiving user or in such a way that the sender of information in a specific category can set the same unit period acquisition information amount to all users.

Setting can also be made according to the type of hardware. In this case, a unit period acquisition information amount, an information amount adjustment method and information presenting timing can be designated depending on which is a receiving terminal, a personal computer, a PDA or a pager.

Similarly, setting can also be modified for each other attribute, such as the type of software, the importance/priority of information, an environmental situation (day of the week, date, time zone, weather, etc.), etc. Furthermore, a unit period acquisition information amount, the setting of the information amount adjustment module 12 and the setting of the information presenting timing adjustment module 13 can also be modified according to the combination of a variety of attributes.

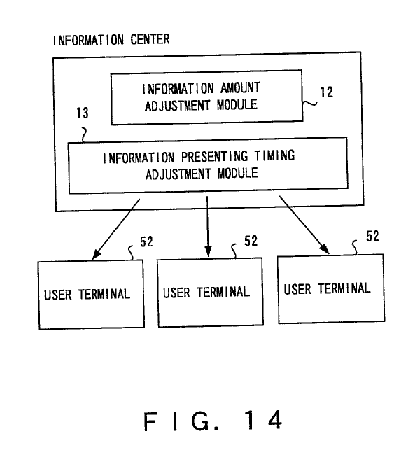

Next, the relation between an information provision source and a user terminal in the information presenting system is described. If a user terminal has no sufficient capacity in a CPU (central processing unit), a memory, etc., it is difficult to perform a complex process using the terminal. Therefore, as shown in FIG. 14, the server 51 of the information center is provided with both an information amount adjustment module 12 and an information presenting timing adjustment module 13, and information is transmitted to a user terminal 52 after information is adjusted for each user on the information provision source side. In this way, the configuration of the user terminal 52 can be simplified.

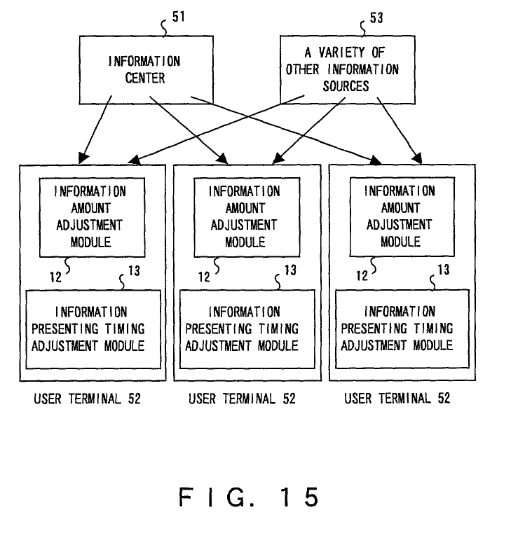

Conversely, if a user terminal has a sufficient capacity in a CPU, a memory, etc., as shown in FIG. 15, each user terminal 52 can be provided with an information amount adjustment module 12 and an information presenting timing adjustment module 13. In this case, the user terminal 52 receives information transmitted from the information center 51 and a variety of other information sources, adjusts both the information amount and information presenting timing, and presents the information to a user.

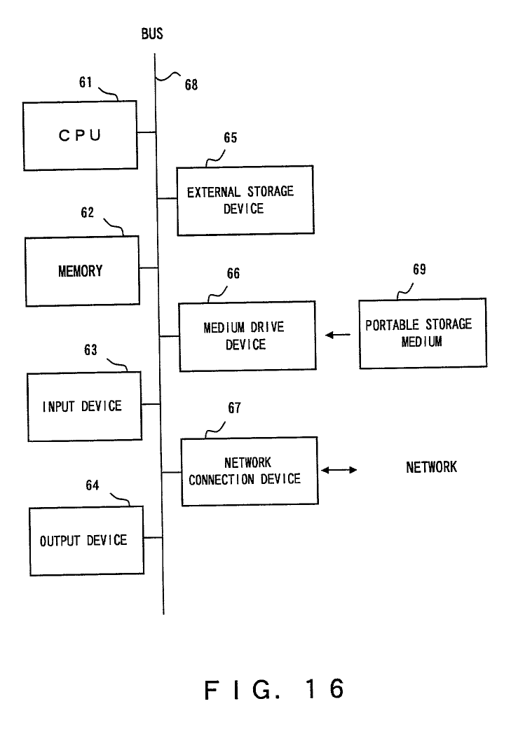

However, the information presenting system described above can be configured using the information processing device (computer) shown in FIG. 16. The information processing device shown in FIG. 16 comprises a CPU 61, a memory 62, an input device 63, an output device 64, an external storage device 65, a medium drive device 66 and a network connection device 67 and they are connected to each other via a bus 68.

The memory 62 includes, for example, a ROM (read-only memory), a RAM (random-access memory), etc. The memory 62 stores obtained information and the program and data used for the process. The CPU 61 performs necessary processes by using the memory 62 and executing the program.

The input device 63 includes, for example, a keyboard, a pointing device, a touch panel, etc. The input device 63 is used to input both user's instructions and information. The output device 64 includes, for example, a display, a printer, a speaker, etc. The output device 64 is used to output both inquiries to a user and information.

The external storage device 65 includes, for example, a magnetic disk device, an optical disk device, a magneto-optical disk, etc. The external storage device 65 stores obtained information. The program and data described above can also be stored in this external storage device 65 and can also be used by loading the program and data into the memory, if required.

The medium drive device 66 drives a portable storage medium 69 and accesses the recorded content. For the portable storage medium 69, an arbitrary computer-readable storage medium, such as a memory card, a floppy disk, a CR-ROM (compact disk read-only memory), an optical disk, a magneto-optical disk, etc., can be used. The program and data described above can also be stored in this portable storage medium 69, and can also be used by loading the program and data in the memory 62, if required.

The network connection device 67 communicates with an outside device via an arbitrary network (line), such as a LAN (local area network), etc., and transmits/receives data accompanying communications. If required, the network connection device 67 can also receive the program and data described above from an outside device, and the program and data can also be used by loading the program and data into the memory 62.

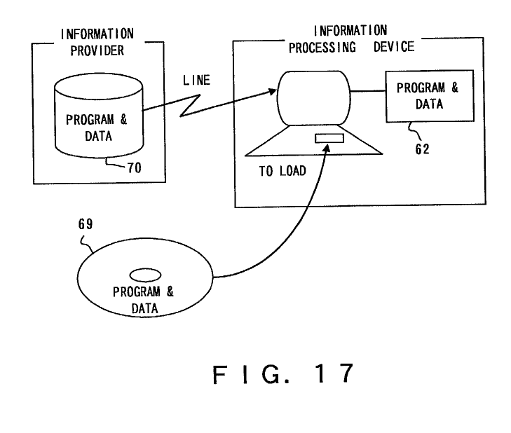

FIG. 17 shows examples of computer-readable storage media for supplying the information processing device shown in FIG. 16 with both a program and data. The program and data stored in the portable storage medium or an outside database 70 are loaded into the memory 62. Then, the CPU 61 performs necessary processes by using the data and executing the program.

According to the present invention, a user can efficiently utilize presented information. The user, for example, can collect an appropriate amount of information at an appropriate timing and can also smoothly does works other than information collection (main job). The user also can receive an amount of information that matches his/her process speed and can also keep time spent in information processing constant. Therefore, a user never holds too much information to read through. Furthermore, since the timing of information presenting can be restricted, work safety can also be improved.

Since the sender of information can also do an effective advertisement for the receiver, information can be effectively utilized by both the sender and receiver.

What is claimed is:

1. An information presenting device, comprising:
an information amount adjustment device adjusting an amount of information to be presented; and
an information presenting timing adjustment device adjusting a timing of presenting information.

2. The information presenting device according to claim 1, further comprising
an output device outputting information adjusted by at least one of said information amount adjustment device and said information presenting timing adjustment device.

3. The information presenting device according to claim 2, wherein after said information amount adjustment device adjusts the amount of information to be presented, said information presenting timing adjustment device adjusts a timing of presenting the adjusted information, and said output device presents the information at a timing adjusted by said information presenting timing adjustment device.

4. The information presenting device according to claim 2, wherein after said information presenting timing adjustment device adjusts the timing, said information amount adjustment device adjusts the amount of information to be presented at the adjusted timing, and said output device presents the information adjusted by said information amount adjustment device.

5. An information presenting device, comprising:
a setting device setting a unit period information amount for indicating an amount of information to be presented during a unit time period; and
a processing device performing a process for presenting information based on the unit period information amount.

6. The information presenting device according to claim 5, wherein said setting device includes a device setting a unit information amount, and sets the unit period information amount using the unit information amount and the unit time period.

7. The information presenting device according to claim 5, wherein said setting device sets the unit period information amount for at least one attributes of a user, category of information, type of hardware, type of software, importance of information, priority of information and an environmental situation.

8. The information presenting device according to claim 5, wherein said setting device automatically sets the unit period information amount based on a user's operation history.

9. The information presenting device according to claim 5, wherein said processing device includes an information amount adjustment device adjusting an amount of information to be presented to the unit period information amount.

10. The information presenting device according to claim 9, wherein said information amount adjustment device adjusts the amount of information to be presented for at least one attributes of a user, category of information, type of hardware, type of software, importance of information, priority of information and an environmental situation.

11. The information presenting device according to claim 9, wherein said information amount adjustment device adjusts the amount of information to be presented in such a way that information effective for at least one of a receiver and a sender of the information can be presented.

12. The information presenting device according to claim 9, wherein said information amount adjustment device selects a content of information in accordance with presenting timing.

13. The information presenting device according to claim 9, further comprising
a collection device positively collecting information when the amount of information to be presented is less than the unit period information amount.

14. The information presenting device according to claim 9, wherein said information amount adjustment device adjusts the amount of information to be presented based on a user's behavior history.

15. The information presenting device according to claim 9, wherein said information amount adjustment device adjusts information generated in real time.

16. The information presenting device according to claim 5, wherein said processing device includes an information presenting timing adjustment device distributing information of the unit period information amount during the unit time period.

17. The information presenting device according to claim 16, wherein said information presenting timing adjustment device adjusts information generated in real time.

18. An information presenting device, comprising:
an information presenting timing adjustment device adjusting a timing of presenting information to a user's free time based on a user's behavior; and
a processing device performing a process for presenting information at the adjusted timing.

19. The information presenting device according to claim 18, wherein said information presenting timing adjustment device automatically sets the timing based on a user's behavior history.

20. An information presenting device, comprising:
an information presenting timing adjustment device adjusting a timing of presenting information based on at least one attributes of a user, category of information, type of hardware, type of software, importance of information, priority of information and an environmental situation; and
a processing device performing a process for presenting information at the adjusted timing.

21. An information presenting device, comprising:
an information presenting timing adjustment device adjusting a timing of presenting information in such a way that information effective for at least one of a receiver and a sender of the information can be presented; and
a processing device performing a process for presenting information at the adjusted timing.

22. An information server, comprising:
an information amount adjustment device adjusting an amount of information to be presented;
an information presenting timing adjustment device adjusting a timing of presenting information; and
a transmitting device transmitting the adjusted information.

23. An information storage device, comprising:
a setting device setting a unit period information amount for indicating an amount of information to be obtained during a unit time period; and
an information amount adjustment device adjusting an amount of information to be obtained to the unit period information amount.

24. A computer-readable storage medium on which is recorded a program for enabling a computer to execute a process, said process comprising:
adjusting an amount of information to be presented; and
adjusting a timing of presenting information.

25. A computer-readable storage medium on which is recorded a program for enabling a computer to execute a process, said process comprising:
setting a unit period information amount for indicating an amount of information to be presented during a unit time period; and
performing a process for presenting information based on the unit period information amount.

26. A computer-readable storage medium on which is recorded a program for enabling a computer to execute a process, said process comprising:
adjusting a timing of presenting information to a user's free time based on a user's behavior; and
performing a process for presenting information at the adjusted timing.

27. An information presenting method, comprising:
setting a unit period information amount for indicating an amount of information to be presented during a unit time period;
adjusting an amount of information to be presented to the unit period information amount;
adjusting a timing of presenting information; and
presenting the adjusted information at the adjusted timing.

28. An information presenting device, comprising:
information amount adjustment means for adjusting an amount of information to be presented; and
information presenting timing adjustment means for adjusting a timing of presenting information.

29. An information presenting device, comprising:
setting means for setting a unit period information amount for indicating an amount of information to be presented during a unit time period; and
processing means for performing a process for presenting information based on the unit period information amount.

30. An information presenting device, comprising:
information presenting timing adjustment means for adjusting a timing of presenting information to a user's free time based on a user's behavior; and
processing means for performing a process for presenting information at the adjusted timing.
